(19) United States
(12) Patent Application Publication
(10) Pub. No.: US 2022/0051278 A1
(43) Pub. Date: Feb. 17, 2022

(54) METHOD AND APPARATUS FOR MANAGING CRYPTOCURRENCY REWARDED FOR A RESPONSE SELECTED BY A DRAW AMONG RESPONSES TO A QUESTIONNAIRE

(71) Applicant: MILLION CIRCLE CO., LTD., Gyeonggi-do (KR)

(72) Inventor: Ki-Man BYUN, Seongnam-si (KR)

(73) Assignee: MILLION CIRCLE CO., LTD., Seongnam-si ,Gyeonggi-do (KR)

(21) Appl. No.: 17/417,056

(22) PCT Filed: Dec. 20, 2019
(86) PCT No.: PCT/KR2019/018230

§ 371 Date: Jun. 21, 2021

(30) Foreign Application Priority Data
Dec. 21, 2018 (KR) 10-2018-0167489

(51) Int. Cl. G06Q 30/02; G06Q 20/36; G06Q 20/38; G06Q 40/02

(52) U.S. Cl. CPC G06Q 30/0212; G06Q 30/0217; G06Q 30/0215; G06Q 20/3678; G06Q 30/0277; G06Q 20/381; G06Q 40/02; G06Q 30/0273; G06Q 20/389

(57) ABSTRACT

The apparatus for managing cyptocurrency rewarded for a response selected via lottery comprises: memory for storing commands; and a processor for executing actions in accordance with the commands. The actions executed in accordance with the commands comprise: transmitting, to a server, responses to a questionnaire associated with an advertisement after same transmitted to a client device is viewed; selecting one or more responses from among the responses transmitted from users; informing the client device that transmitted the selected response of the selection which includes a reward; receiving, from the client device that received the selection notification, information concerning receiving cryptocurrency; and paying cryptocurrency, which is legal tender, corresponding to the reward.

### FIELD OF INVENTION

The present invention relates to management and a method of cryptocurrency rewarded for a response selected by a draw among responses to a questionnaire, and more particularly to a method and apparatus for payment and management of cryptocurrency when a user responds to a given questionnaire through a computer or mobile devices after watching an advertisement and a reward paid for one or more responses selected by a draw among collected responses is cryptocurrency.

### BACKGROUND OF INVENTION

Bitcoin, which was announced as open-source software in 2009, is considered as the world's first blockchain-based cryptocurrency, and may usually be defined as an electronically existing digital currency. With respect to Bitcoin, there is no central issuing authority or political organization that controls the amount of Bitcoin in circulation. Without having to rely on the government to issue new currency, a blockchain program of the Bitcoin processes the time of producing the Bitcoin and the amount thereof and tracks the location of the Bitcoin. As of September 2018, the number of Bitcoins is 17.30 million, and the total supply is limited to 21 million. Bitcoin as a cryptocurrency in a Bitcoin system may only be issued by mining.

Unlike the cryptocurrency issuance method on the Bitcoin blockchain, since the token sale called initial coin offering (ICO) was first conducted by Mastercoin in 2013, Ethereum has succeeded in raising large-scale funds through a token sale in 2014, and since then, cryptocurrency issuance by ICO has become mainstream.

The cryptocurrency market is changing rapidly every day, and crypto experts constantly create new currencies, and accordingly cryptocurrency grows exponentially. Since cryptocurrencies are capable of being created through an open source method, anyone having proper coding knowledge for cryptocurrency creation is capable of easily creating cryptocurrencies, and the number of cryptocurrencies is expected to continue to increase in the future. As of this writing, it is estimated that there are about 2,500 cryptocurrencies on the current status board of investing.com.

However, in relation to cryptocurrency and the market therefor, nothing recognized as having entered the stabilization stage has been discovered, and the controversy over the viability of cryptocurrency continues. There are a lot of cryptocurrencies pouring out every day, but on the other hand, there are also a lot of cryptocurrencies that disappear. The value of cryptocurrency is also very volatile, causing anxiety and inconvenience to those who use or invest in cryptocurrency. When a value of cryptocurrency of users and investors plummets or an issuing entity of the cryptocurrency goes bankrupt, the users and the investors have no choice but to bear the losses.

### SUMMARY OF INVENTION

### Technical Problem to be Solved

The present invention is to solve the problems in the prior art, and according to the present invention, the amount of fiat money corresponding to cryptocurrency acquired as a reward for performing a task given in a predetermined form may be deposited or entrusted to a credit institution such as a financial institution, the deposited amount of fiat money may be returned by re-exchange, and thus a cryptocurrency acquirer may compensate for losses caused by sudden fluctuations in cryptocurrency.

### Technical Solution

According to the present invention, a management apparatus of cryptocurrency rewarded to a response selected by a draw includes a memory configured to store commands, and a processor configured to execute operations according to the commands. The operations executed according to the commands may include transmitting a response to questionnaire related to advertisement after watching the advertisement transmitted to a client device, determining at least one response among responses transmitted from users, notifying a client device that transmits a winning response of a fact of winning including a reward, receiving information of receipt of cryptocurrency from a client device that receives the winning response, and paying cryptocurrency corresponding to a reward of fiat money.

According to an aspect of the present invention, acquisition of cryptocurrency may be an event that occurs in relation to a user (consumer) who achieves a predetermined type of task provided by a server. The task may be achieved by a predetermined action of the user. The task according to the present invention may be performed by a series of actions related to advertisement, and according to an embodiment, the task may be presented in the form of an advertisement or a questionnaire related thereto. After viewing the presented advertisement, the user may achieve the task by responding to questions recorded in the questionnaire. The series of questions may include a quiz, a survey, or research, which is directly related to advertisement.

According to another aspect of the present invention, cryptocurrency refers to digital currency that uses cryptography for security, and in detail, digital currency in a distributed system based on blockchain technology. Therefore, cryptocurrency may include those that are validly traded on cryptocurrency exchanges, including Bitcoin, Ethereum, Ripple, and Litecoin, and may also include any cryptocurrency created based on legal regulations and technology for cryptocurrency issuance.

According to another aspect of the present invention, when a user completes a predetermined task and acquires qualification to acquire cryptocurrency by a draw, a fiat money amount corresponding to cryptocurrency the user acquires may be deposited or entrusted to a credit institution such as a financial institution. Here, the draw may be executed for users who transmit the result (response) to the server after performing the task, and the user who obtained the reward by a draw may be basically given a reward of fiat money. For the reward amount expressed in fiat money, for example, the amount of cryptocurrency may be paid to a winner according to an exchange ratio with a fiat money price for the cryptocurrency in an exchange at the time of acquiring cryptocurrency.

According to an aspect of the present invention, when a user replaces the reward of fiat money that he or she acquires and receives the reward in cryptocurrency, the reward of fiat money may be escrowed, and thus the user may return the owned cryptocurrency and may exchange the cryptocurrency with the reward of fiat money after a predetermined time elapses.

### Effect of Invention

The cryptocurrency market has experienced an unprecedented boom, and the interest of the general public in cryptocurrency has also been increased. However, there are still aspects of cryptocurrency that have not yet been established as a safe asset, and value fluctuations are still insecure.

The present invention proposes a new method of acquiring cryptocurrency by acquiring cryptocurrency as a reward after a task is completed. When cryptocurrency is acquired by replacing a reward of fiat money acquired by a draw after a task is completed, the reward of fiat money is deposited or entrusted and then the cryptocurrency is given up and is returned, thereby contributing to activating, stabilizing, and promoting transactions in the cryptocurrency.

### BRIEF DESCRIPTION OF DRAWINGS

FIG. 1 is a system block diagram showing an exemplary network environment for explaining a method of delivering advertisements created by an advertiser to a user through an advertisement publisher according to embodiments of the present invention.

FIG. 2 is a diagram showing an example of the case in which an advertisement is displayed on a client device in the system environment of FIG. 1 according to embodiments of the present invention, FIG. 2A is a home screen and FIG. 2B is a diagram showing a separate screen for displaying linked content.

FIG. 3 is a flowchart illustrating an exemplary overall process of posting an advertisement on a client device, responding to questionnaires of a user, selecting a winner, selecting a prize or cryptocurrency, and paying a reward according to embodiments of the present invention.

FIG. 4 is a network block diagram showing a method of managing cryptocurrency paid as a reward in a blockchain-based system when a user receives cryptocurrency as a reward paid as a result of draw in response to response to a questionnaire according to embodiments of the present invention.

FIG. 5 is a lookup table of files of winners of a cryptocurrency management server in the block diagram of FIG. 4.

FIG. 6 is a table showing a change in cryptocurrency deployed on the blockchain and the amount of deposit in the block diagram of FIG. 4.

FIG. 7 is a block diagram showing components in the form of a computer for reading commands from a machine (computer) readable medium and executing one or more methods discussed in the present invention according to embodiments of the present invention.

### BEST MODE

Reference will now be made in detail to embodiments, examples of which are illustrated in the accompanying drawings.

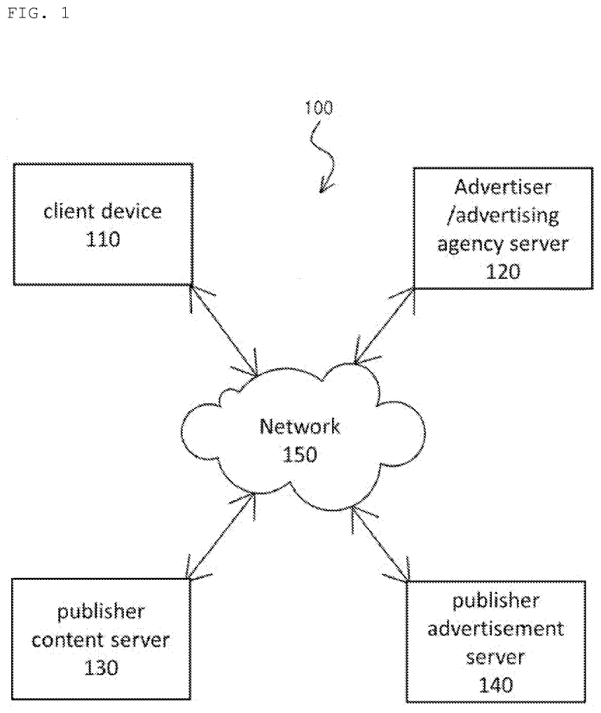

FIG. 1 is a system block diagram showing an exemplary network environment for explaining a method of delivering advertisements created by an advertiser to a user through an advertisement publisher according to embodiments of the present invention. A network environment 100 may include a client device 110, a publisher content server 130, and a publisher advertisement server 140. When advertisement is directly distributed by an advertiser, the network environment 100 may further include an advertiser/agency advertising server 120.

A client device, that is, a user device 110 may include a desktop computer, a lap top computer (called a notebook computer), a tablet computer, a smartphone, and other devices, and computing devices such as devices for receiving and reproducing a stream of video and/or other multimedia content. The client device 110 may include a display or another user interface configured (preferred) to display content such as processed images, web pages, documents, or video content.

The client device 110 may request content from websites through a network 150 such as the Internet and may receive content from the websites. The network 150 may include a public network (e.g., the Internet), a private network (e.g., a local area network (LAN), or a wide area network (WAN)), a wired network (e.g., an Ethernet network), a wireless network (e.g., a Wi-Fi network), routers, hubs, switches, server computers, and/or a combination thereof.

In some embodiments, a user may request a web page as a search target to the publisher content server 130 through the network 150 using the client device 110, and the publisher content server 130 may transmit the requested web page to the client device 110 in response to the request. In this case, various types of advertisements (e.g., banner, pop-up and pop-under, or video ad) may be executed and displayed by the publisher advertisement server 140 in an advertisement space (advertising or ad space) allocated to a web page provided by the publisher content server 130. If the advertiser site distributes advertisements directly or delegates work to an advertisement agency, the advertiser/agency advertising server 120 may display the advertisements on the web page provided by the publisher content server 130.

Many of the advertisements (including video advertisements) displayed on the client device 110 of the user by the advertisement servers 120 and 140 only contain, in short, links to specific web pages of the advertisement servers 120 and 140 of a publisher or an agency. For these types of advertisements, when the user clicks an advertisement displayed on a screen of the client device 110, an Internet browser of the user may connect the client device 110 to a specific web page of the publisher advertisement server 140 or the advertiser/agency advertising server 120, and thus the user may watch the clicked advertisement. Hereinafter, how this process is performed will be described using display advertising, more specifically, banner ads, which is one of the representative advertisements among display advertisements, as an example.

The display advertising is, in short, advertising on a website, which is provided in a variety of formats. The display advertising includes various items such as text, an image, flash, video, and audio. The display advertising is an online form of advertisement in which a promotional message of a company (advertiser) is displayed on a third-party site such as an advertisement publisher or social network or on a search engine result page.

Banner advertising is one of the representative forms of display advertising. At one time, banner advertising was mainly used as display advertising, but as banner advertising is rejected by users who are fed up with the flood of advertisements, an advertisement connection rate is reduced, and the effectiveness of banner advertising is being questioned. However, banner advertisement is still positioned as a major medium in the advertising market while maintaining its ripple effect. Above all, the banner advertisement is an example suitable for understanding an advertisement system related to FIG. 1 of the present invention.

The banner advertisement is, in short, a special type of hypertext link. A basic role of a text link is that, when a user clicks a portion of a text, a series of HTML codes instructs a web server to fetch a specific web page. The banner advertisement is essentially the same as a text link, except that the banner advertisement is displayed as a box containing graphics (usually with text elements) and sometimes animations instead of text. Needless to say, the banner advertisement may further include files such as video or audio.

When a user surfs the web through a web browser driven on the client device 110, a large number of advertisements is posted on a web page or a series of web pages provided from the publisher content server 130 by the advertisement servers 140 and 120. These advertisements displayed on web pages provided by the publisher content server 130 may be displayed on a search engine result page in a web browser as a result of a user inputting a search term, or when a user enters a web address or URL as a result of typing, the advertisements may be displayed as a new tab or window within the web browser. As described above, the advertisements displayed on the screen of the client device 110 by searching or entering a web address may be, in short, hypertext links. When a user clicks one of the banner advertisements that attracts his or her interest among advertisements displayed on the client device 110, the web browser may connect the client device 110 to the web server (140 or 120 in the embodiment), on which the clicked banner advertisement is stored, to request the corresponding web page, and accordingly, the user may watch the advertisement clicked by himself or herself.

Through this process, the web browser of the client device 110 may pull a desired web page from the web servers (120, 130, and 140 in the embodiment) through the network 150 and may display the web page on the screen of the client device 110, that is, a browser.

The web browser may also interpret a set of HTML tags within the web page and may display the web page on a screen of the client device 110 in a way in which a web page creator wants the web page to be displayed. The web page may have a HTML tag for describing a method of formatting a text when a text and a browser display a page on the screen. Tags are commands indicating a figure in which a web page needs to be displayed when a web browser displays the web page. The tags may instruct the web browser to perform a task such as changing font size or color or arrangement of objects in columns. In other words, the web browser may interpret the tags in order to determine how the text needs to be formatted on a screen.

So far, a method of viewing various types of advertisements including banner advertisements on the client device 110 through a browser, that is, a web browser, has been described.

Needless to say, unlike a desktop or laptop computer, advertisements may also be displayed through various apps, which are driven by mobile devices, provided by an advertisement publisher operating the publisher content server 130 or other developers. For example, an operator of the publisher content server 130 may receive advertisements from many advertisers and may distribute advertisements through applications installed in the mobile client device 110. In the case of distribution of advertisement through an application driven in a mobile device, the advertisement may be displayed on the client device 110 through a mobile browser, which is a web browser suitably designed for a mobile device such as a smartphone or PDA.

In the case of advertisements using mobile applications, advertisements displayed on web pages provided by the publisher content server 130 may include only minimum information including hyperlinks to a specific advertisement web page stored on the publisher advertisement server 140 or the advertiser/agency advertising server 120, as described above. Accordingly, when an advertisement (e.g., an advertisement displayed in an advertisement space or a popup advertisement) in a web page displayed on the mobile browser of the client device 110 is clicked, a specific advertising web page on the publisher advertisement server 140 or the advertiser/agency advertising server 120 may be reconnected. Through this process, the user may watch the advertisement selected by the user.

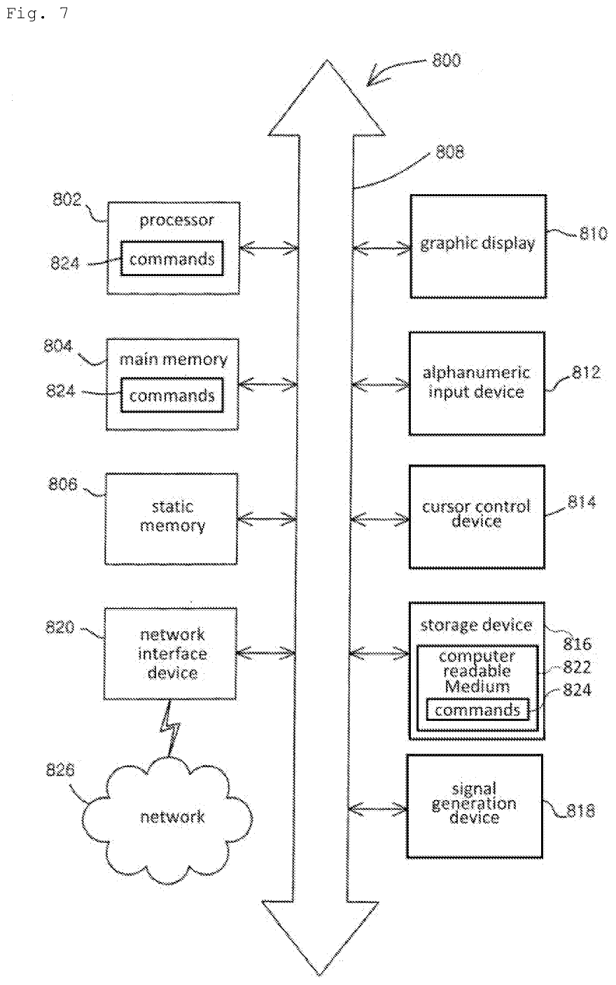

The machines, devices, or databases shown in FIG. 1 may all be realized by configuring or programming a general-purpose computer to become a special purpose computer by software. A computer system capable of implementing one or more of the methods described herein will be described below with respect to FIG. 7. Any two or more of the machines shown in FIG. 1 may be combined into one machine, and functions described in one machine may be subdivided into several machines.

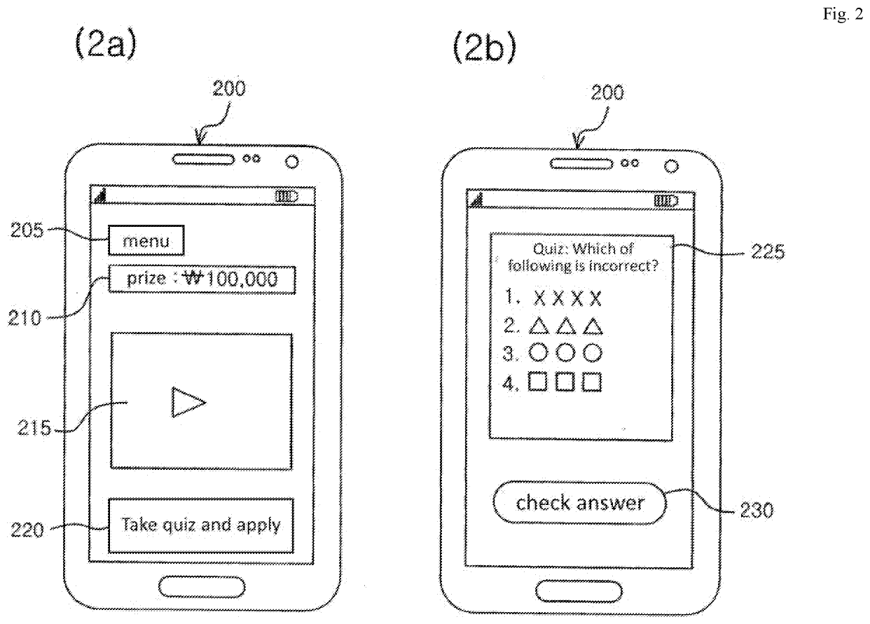

FIG. 2 is a diagram showing an example of the case in which an advertisement is displayed on a client device in the system environment of FIG. 1 according to embodiments of the present invention. FIG. 2A is a home screen and FIG. 2B is a diagram showing a separate screen for displaying content link through a user interface on a home screen. In the example of FIG. 2, a smartphone 200 among mobile devices may be used as an example of the client device 110. When the user clicks or touches an application of an advertisement publisher among icons displayed on the home screen of the client device, that is, the smartphone 200, the home screen of the application shown in FIG. 2A may be displayed on the smartphone 200. The home screen of the app may include buttons such as a prize display 210 and a button 220 for taking a quiz and participation, and an advertisement 215 to be displayed (e.g., a video advertisement) placed in the center of the screen. In addition, when a menu button 205 is touched, explanations about the operation and function of an application, ongoing campaigns, and rewards given when participating in the questionnaire may be configured to be searched for.

When the user presses a play button of the advertisement 215, the advertisement content may be properly displayed on the screen of the smartphone 200 through the process described above with reference to FIG. 1. When the user takes the quiz after watching the advertisement and presses a button for participation, the content linked by the navigation may be displayed on a next screen of the smartphone 200 (FIG. 2B). When the user solves a quiz 225 presented in the form of a questionnaire and then presses a correct answer check button 230, the presence or absence of the correct answer may be displayed on the screen of the smartphone 200. When the answer to the quiz is correct, the response may be transmitted to and stored on the response management server (not shown) of the advertisement publisher from the client device 110 (here, the smartphone 200) through the network 150. Here, the response management function may be hardware configured or programmed to be processed by the publisher content server 130 or the publisher advertisement server 140 without using a separate server.

In embodiments of the present invention, the task may be presented, for example, in the form of a questionnaire relating to advertising and/or promotion. The questionnaire may include quizzes directly or indirectly related to advertisements and/or public relations, research related to products or services, and surveys, and may also include a combination thereof. Therefore, when a user who has viewed an advertisement transmits a response to a response management server of a publisher for a quiz or research, the response management server may collect, categorize, and store responses from users, and may then store these responses, and when an event campaign such as advertisement ends, the response management server may select at least one winner by a draw from among the responses. These campaigns may be repeatedly implemented and managed as rounds with a regular cycle.

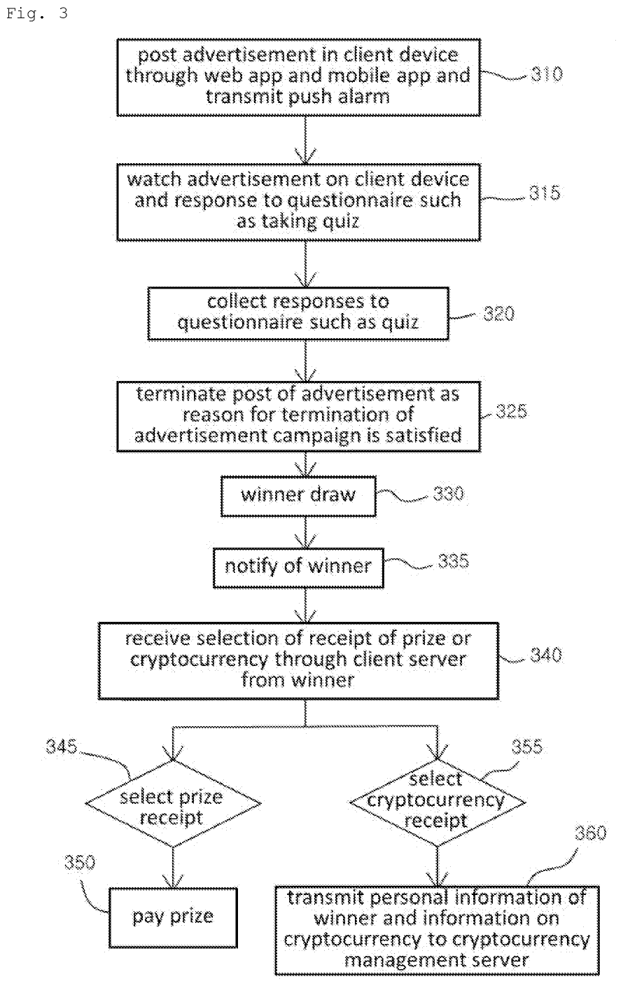

FIG. 3 is a flowchart illustrating an exemplary overall processes of posting an advertisement on a client device, responding to questionnaires of a user, selecting a winner, selecting a prize or cryptocurrency, and paying a reward according to embodiments of the present invention. The method discussed herein may be performed by processing logic including hardware (e.g., circuitry, dedicated logic, programmable logic, or microcode), software (e.g., instructions executed on a processing device to perform a hardware simulation), or a combination thereof. A web page publisher, through for example, the publisher content server 130 and the publisher advertising server 140, transmits and posts advertisement to the client device 110 such as a computer (e.g., a desktop) or mobile devices (e.g., a smartphone) through a web application or a mobile application. In the case of mobile devices, a push alarm may also be additionally and appropriately transmitted (operation 310). Needless to say, advertising may be placed in response to an active request from the client device 110.

In a subsequent step 315, when a user watches the advertisement 215 displayed on his or her client device 110 (e.g., the smartphone 200) and clicks the button for taking a quiz and applying for 220, content of the quiz 225 related to the advertisement is displayed. If the user responds to a questionnaire such as a quiz and then presses the correct answer button 230, the response to the questionnaire is considered complete when the answer is checked as being correct for the questionnaire requiring a correct answer like a quiz. Then the response is transmitted to a publisher's response management server. In the case of a questionnaire that asks for opinions such as research, the response itself to the questionnaire is considered complete and is transmitted to the publisher's response management server. Through these processes, responses to questionnaires such as quizzes are collected (step 320).

Publishing of advertisements stops when the reasons for termination of the campaign are satisfied such as a time lapse or attainment of the number of target audiences (step 325). Then, at least one winner is determined among responses collected by a draw (step 330) and then notification of the winning is made to the winner along with rewards and announcement (step 335).

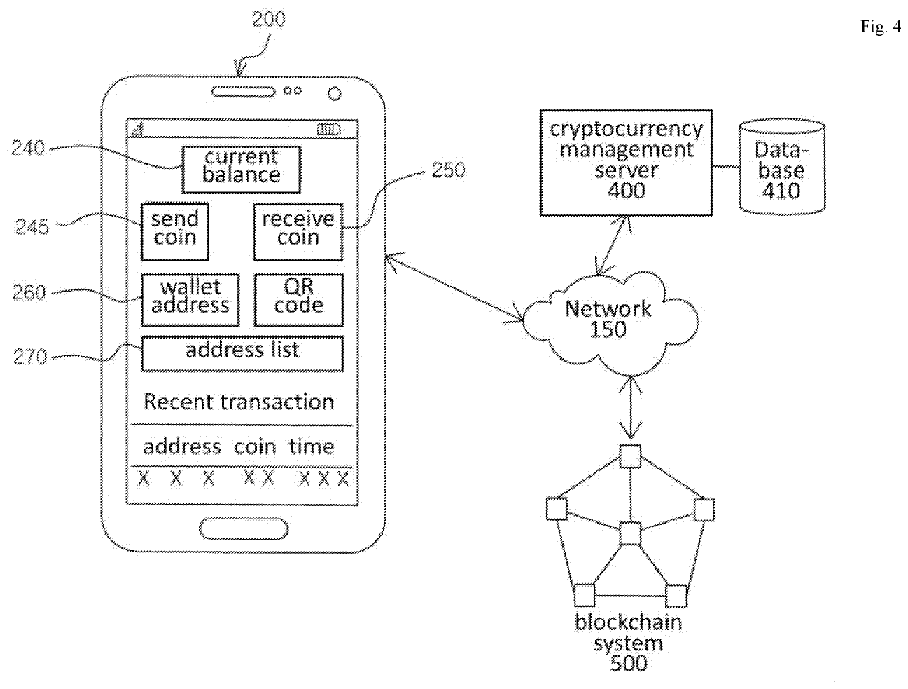

In response to the notification, the winner transmits information on whether to receive a reward (which is fiat currency) or crypto currency equivalent to the reward to the publisher management server through his or her client device 110 (e.g., the smartphone 200) (step 340). When the winner selects to receive a prize (reward) (step 345), the prize is to be paid (step 350), while when the winner selects to receive a cryptocurrency (step 355), information on personal information of the winner and cryptocurrency is transmitted to the cryptocurrency management server 400 (refer to FIG. 4) (step 360).

FIG. 4 is a network block diagram showing a method of managing cryptocurrency paid as a reward in a blockchain-based system when a user receives cryptocurrency as a reward paid as a result of draw in response to response to questionnaire according to embodiments of the present invention. The blockchain-based crypto currency management system includes the client device 110 (e.g., the smartphone 200), the cryptocurrency management server 400, and a database 410 for storing data of personal information on winners, acquired rewards, selection of prize receipt, etc. As shown in FIG. 4, a digital wallet (e.g., Bitcoin wallet or Ethereum wallet) for cryptocurrency transaction through access to a blockchain system 500 is installed on the smartphone 200. A current balance 240 indicates the amount of cryptocurrency currently stored in a digital wallet of a user, and cryptocurrency can be transmitted and received through a user interface for coin sending 245 and coin receiving 250. A wallet address 260, called a public key, allows users to perform transactions of transmitting and receiving cryptocurrency there through. When two or more blockchain addresses are generated, they can be managed through an address list 270.

The cryptocurrency management server 400 is configured to manage transactions of cryptocurrency when receipt of the cryptocurrency is selected by winners who have chosen the crypto currency in lieu of a reward and belong to winners selected by a draw among responders who have completed the task according to the present invention. The database 410 also stores data related to the cryptocurrency.

The smartphone 200, the cryptocurrency management server 400, and the blockchain system 500 are all connected to each other for communication between them through the network 150. The network 150 may include a public network (e.g., the Internet), a private network (e.g., a local area network (LAN), or a wide area network (WAN)), a wired network (e.g., an Ethernet network), a wireless network (e.g., a Wi-Fi network), routers, hubs, switches, server computers, and/or a combination thereof.

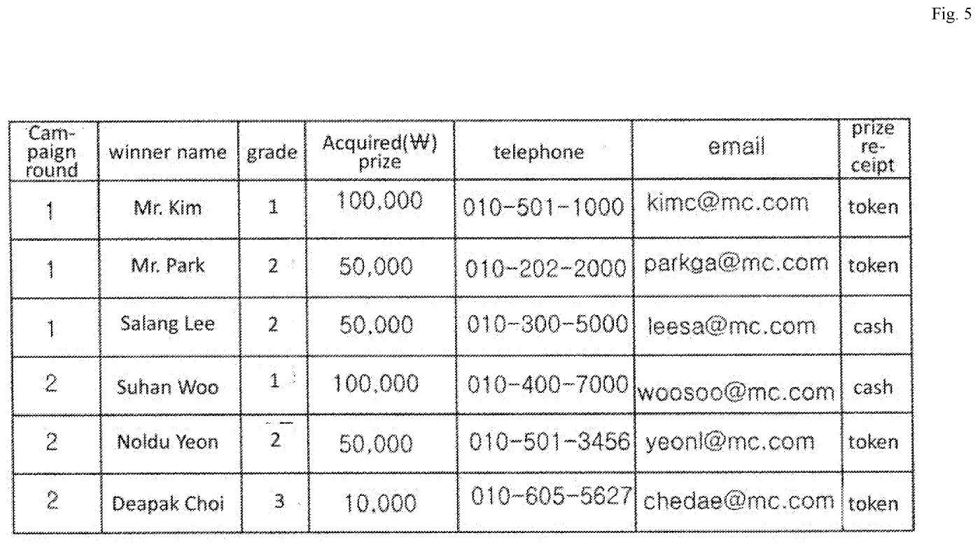

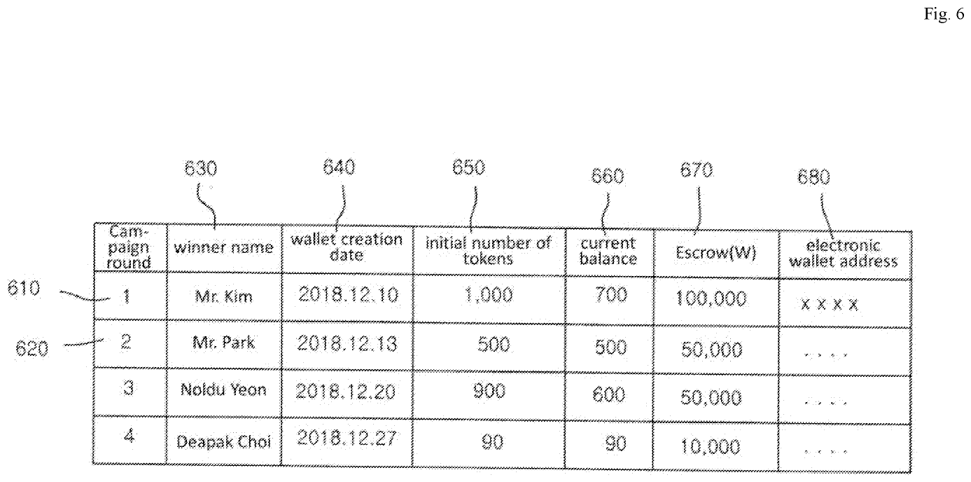

FIG. 5 is a lookup table of files of winners of a cryptocurrency management server in the block diagram of FIG. 4. FIG. 6 is a table showing a change in cryptocurrency deployed in the blockchain and the amount of deposit in the block diagram of FIG. 4. The cryptocurrency is a digital asset designed to serve as a medium of exchange and uses strong cryptography to stabilize financial transactions, control additional issuance, and verify transfer of assets. The cryptocurrency is a kind of alternative currency and digital currency. Many cryptocurrencies use a decentralized system based on blockchain technology. The issuance of cryptocurrency does not involve any centralized authority or central bank, and thousands of types of cryptocurrency are transacted today. The first blockchain-based cryptocurrency is Bitcoin, which is still the most popular and valuable cryptocurrency on the market. The opposite of cryptocurrency is fiat money.

According to embodiments of the present invention, a user, through his or her client devices 110 and 200, watches advertisements presented and transmits an appropriate response to a given task (written in questionnaire format) to the publisher response management server. It is a basic rule that at least one winner is selected by a draw among the responses transmitted from users and a reward of fiat money is provided to the winner. In relation with the reward of fiat money, the winner is able to receive whether a prize of fiat money or a crypto currency in lieu of the prize, the amount of the cryptocurrency being calculated based on an appropriate exchange value such as an exchange rate on the coin market at the time of receiving the reward. These campaigns are repeatedly implemented and managed at regular intervals.

Referring to FIGS. 4 to 6, when a winner receives a reward in cryptocurrency instead of fiat money, the cryptocurrency management server 400 manages changes in crypto currency. In the table of FIG. 5, each row has records on all necessary data for each of the individual winners, and field values for each row includes a winner name, a grade, an acquired prize, a phone number, an email, and selection of a prize receipt. Here, when the selection of a prize receipt is a token, that is, a cryptocurrency, an amount equivalent to the won prize in fiat money is deposited or entrusted and escrowed in a credit institution such as a bank.

The table of FIG. 6 shows a method of acquiring and managing a cryptocurrency such as Bitcoin or Ether on the blockchain by a user when the winner selects and receives a token. As seen from row 1, the winner with the name “Mr. Kim” created a wallet on Dec. 10, 2018 (640), and received 1,000 tokens for the first time by replacing the reward (650). The early number of tokens 650 are those that was received in lieu of the escrow amount 670, and the escrow amount 670 corresponds to a reward represented by fiat money. Since the current balance is 700 tokens (660), it is confirmed that the cryptocurrency has been transacted after creation of the wallet. On the other hand, as seen from row 2, “Mr. Park” 630 has the same initial number of tokens 650 and current balance 660, which means that there has been no cryptocurrency transaction since the blockchain wallet has been created 640, or balance has been maintained to be the same as the initial token receipt status regardless of crypto currency transaction. Actions related to crypto currency on the blockchain of these winners may be identified by tracking an electronic wallet address 680, and here, the electronic wallet address 680 means a public key. This is because anyone having a blockchain account on the blockchain using a database called a distributed ledger is capable of accessing a ledger stored in the blockchain using the public key.

In the table of FIG. 6, the escrow amount 670 may refer to a reward offiat money, and the reward may be acquired during a procedure of performing a task (questionnaire) presented by an advertiser or an advertisement publisher by a user. A winner may receive the reward of fiat money or may also receive cryptocurrency corresponding to the reward. As long as the user maintains the initial number of tokens 650 corresponding to the reward, the user may give up his or her cryptocurrency any time and may get the escrow amount 670 back.

FIG. 7 is a block diagram showing components in the form of a computer for reading commands from a machine (computer) readable medium and executing one or more methods discussed in the present invention according to embodiments of the present invention. FIG. 7 schematically illustrates a machine in the form of an exemplary computer system, in which commands 824 for executing any one or more of the methods discussed here (e.g., software) may be executed. In alternative embodiments, the machine 800 may operate as an independent device or may be connected (e.g., networked) to other machines on a LAN, intranet, extranet or Internet. The machine 800 may operate as a server or a client machine in a server-client network environment, or as a peer machine in a peer-to-peer (or decentralized type) network environment. The machine 800 may be a server computer, a client computer, a personal computer (PC), a tablet computer, a set-top box (STB), a personal digital assistant (PDA), a cellular phone, a web appliance, a network router, a switch or a bridge, or any machine capable of (sequentially or otherwise) executing a set of commands specifying actions to be taken by a corresponding machine. Also, although only a single machine is shown, the term “machine” may be considered as including any combination of machines that individually or jointly execute the commands 824 to perform any one or more of the methodologies discussed herein.

The machine 800 includes a processor 802, a main memory 804 (e.g., a read-only memory (ROM), a flash memory, a synchronous dynamic random access memory (DRAM), or a dynamic random access memory (DRAM) such as a Rambus DRAM (RDRAM)), and a static memory 806 (e.g., a flash memory or a static random access memory (SRAM)), which are configured to communicate with each other via a bus 808.

The processor 802 may be one or more general purpose processing units such as a microprocessor, or a central processing unit. In detail, the processor 802 may be a complex instruction set computing (CISC) microprocessor, a reduced instruction set computing (RISC) microprocessor, a very long instruction word (VLIW) microprocessor, other processors for embodying command sets, or a combination of sets of commands. The processor 802 may also be one or more special purpose processing devices such as an application specific integrated circuit (ASIC) circuit, a field programmable gate array (FPGA), a digital signal processor (DSP), or a network processor. The processor 802 may be configured to execute the commands 824 to perform the operations and steps discussed herein.

The machine 800 may further include a graphic display 810 (e.g., a plasma display panel (PDP), an LED display, or an LCD). The machine 800 may also include an alphanumeric input device 812 (e.g., a keyboard), a cursor control device 814 (e.g., a mouse, a touchpad, a joystick, or other pointing devices), a storage device 816, a signal generation device 818 (e.g., a speaker), and a network interface device 820.

The storage device 816 may include a machine (computer) readable medium 822 for storing the commands 824 (e.g., software) specifying any one or more of the methodologies or functions discussed herein. The commands 824 may also reside completely or at least partially in the main memory 804 and/or in the processor 802 (e.g., in a cache memory of the processor) while the commands are being executed by the machine 800, and thus the main memory 804 and processor 802 may also constitute a machine-readable medium. The commands 824 may be further transmitted or received through a network 826 via the network interface device 820.

Although the machine-readable storage medium 822 is shown as a single medium in an exemplary embodiment, the term “machine (computer)-readable storage medium” may be considered as including a single medium or multiple media for storing a set of one or more commands (e.g., centralized or decentralized database, and/or associated caches and servers). The term “machine-readable storage medium” may also be treated as including any medium capable of storing, encoding, or conveying a set of instructions executed by a machine (e.g., the machine 800), and when executed by one or more processors (e.g., the processor 802) of a machine, the commands may cause the machine to execute any one or more of the methodologies described herein. Accordingly, the “computer-readable storage medium” includes a solid state memory, an optical medium, and a magnetic medium, but is not limited thereto.

The present invention is not limited to the embodiments disclosed above, but may be embodied in various different forms, and these embodiments are provided so that this disclosure will be thorough and complete, and will fully convey the concept of the present invention to those skilled in the art, and the scope of the present invention is defined by the claims. Like reference numerals refer to like elements throughout.

Unless otherwise defined, all terms including technical and scientific terms used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is for the purpose of describing particular embodiments only and is not intended to be limiting of the exemplary embodiments. Singular expressions in the present specification include the plural expressions unless clearly specified otherwise in context.

1. A method performed by a server including a processor, the method comprising:
receiving responses through client devices with respect to a task including at least one questionnaire presented by the server;
determining at least one winning response from among the responses by a draw;
notifying a client device that transmits the winning response of a fact of winning, including information on a reward and cryptocurrency provided for the winning response;
receiving information on receipt of the cryptocurrency from the client device that receives the winning response; and
paying cryptocurrency corresponding to the reward of fiat money by transmitting the cryptocurrency to an electronic wallet installed on the client device through a blockchain using a network.

2. The method according to claim 1, wherein the task is an advertisement, and the questionnaire includes a quiz related to the advertisement.

3. The method according to claim 1, wherein an amount of the paid cryptocurrency corresponding to the reward is calculated based on an appropriate exchange value in a coin market at a time of paying the reward when the reward is paid.

4. The method according to claim 1, wherein, when the cryptocurrency corresponding to the reward is paid, the reward is escrowed in a credit institution.

5. The method according to claim 4, wherein, after the cryptocurrency corresponding to the reward is paid once, when the reward is returned from the electronic wallet of the client device through the network, a client device that transmits the winning response is notified of information on payment of the escrowed reward in response to the returned cryptocurrency.

6. The method according to claim 1, wherein management of transactions of the cryptocurrency is identified by tracking the electronic wallet of the client device.

7. A system comprising:
a server including a processor; and
a memory configured to store executable commands for performing operations when executed by the processor,
wherein the operations include:
receiving responses through client devices with respect to a task including at least one questionnaire presented by the server;
determining at least one winning response from among the responses by a draw;
notifying a client device that transmits the winning response of a fact of winning, including information on a reward and cryptocurrency provided for the winning response;
receiving information on receipt of the cryptocurrency from the client device that receives the winning response; and
paying cryptocurrency corresponding to the reward of fiat money by transmitting the cryptocurrency to an electronic wallet installed on the client device through a blockchain using a network.

8. The system according to claim 7, wherein an amount of the paid cryptocurrency corresponding to the reward is calculated based on an appropriate exchange value in a coin market at a time of paying the reward when the reward is paid.

9. The system according to claim 7, wherein, when the cryptocurrency corresponding to the reward is paid, the reward is escrowed in a credit institution.

10. The system according to claim 9, wherein, after the cryptocurrency corresponding to the reward is paid once, when the reward is returned from the electronic wallet of the client device through the network, a client device that transmits the winning response is notified of information on payment of the escrowed reward in response to the returned cryptocurrency.

11. The system according to claim 7, wherein management of transactions of the cryptocurrency is identified by tracking the electronic wallet of the client device.

12. The system according to claim 7, wherein the task is an advertisement, and the questionnaire includes a quiz related to the advertisement.

13. A non-transitory computer readable storage medium including executable commands for executing operations by a processor when the commands are executed by the processor, the operations comprising:
receiving responses through client devices with respect to a task including at least one questionnaire;
determining at least one winning response from among the responses by a draw;
notifying a client device that transmits the winning response of a fact of winning, including information on a reward and cryptocurrency provided for the winning response;
receiving information on receipt of the cryptocurrency from the client device that receives the winning response; and
paying cryptocurrency corresponding to the reward of fiat money by transmitting the cryptocurrency to an electronic wallet installed on the client device through a blockchain using a network.

14. The non-transitory computer readable storage medium according to claim 13, wherein the task is an advertisement, and the questionnaire includes a quiz related to the advertisement.

15. The non-transitory computer readable storage medium according to claim 13, wherein an amount of the paid cryptocurrency corresponding to the reward is calculated based on an appropriate exchange value in a coin market at a time of paying the reward when the reward is paid.

16. The non-transitory computer readable storage medium according to claim 13, wherein, after the cryptocurrency corresponding to the reward is paid once, when the reward is returned from the electronic wallet of the client device through the network, the reward is escrowed in a credit institution to pay the reward in response to the returned cryptocurrency.
